(19) United States
(12) Patent Application Publication
(10) Pub. No.: US 2010/0213217 A1
(43) Pub. Date: Aug. 26, 2010

(54) LIQUID DISPENSING ASSEMBLY

(75) Inventors: Warren N. Strong, Hope, RI (US); Terrence Woldorf, Westport, MA (US)

Correspondence Address: WOOD, HERRON & EVANS, LLP (NORDSON), 2700 CAREW TOWER, 441 VINE STREET, CINCINNATI, OH, 45202, US

(73) Assignee: NORDSON CORPORATION, Westlake, OH (US)

(21) Appl. No.: 12/390,587

(22) Filed: Feb. 23, 2009

(51) Int. Cl. B65D 83/76; G01F 11/00

(52) U.S. Cl. 222/327; 222/389

(57) ABSTRACT

A dispensing assembly including a cartridge and a retainer. The cartridge includes a dispensing end and defines a reservoir for holding a liquid. The dispensing end includes a connector portion for receiving an end fitting with a rotational connection. The retainer includes a first open end and receives the cartridge such that the connector portion communicates with the first open end in a manner allowing connection of the end fitting. The retainer couples with the cartridge in a manner preventing relative rotation between the cartridge and the retainer.

### TECHNICAL FIELD

This invention relates generally to the field of dispensing liquid materials and, more specifically, to dispensing assemblies.

### BACKGROUND

Various types of dispensers are used in many industries for placing liquids, such as adhesives, conformal coating materials, solder paste, solder flux, and similar materials onto substrates during an assembly process or other processes. One type of liquid dispensing assembly includes a body defining a cartridge with a reservoir for holding a supply of liquid to be dispensed. An end fitting, such as a syringe dispensing tip or other fitting, is coupled to the cartridge at one end and communicates with the reservoir. A piston disposed in the reservoir is movable to pressurize the liquid in the reservoir and thereby dispense the liquid onto a substrate.

Typically, the end fitting, such as the syringe dispensing tip, is coupled to a connector portion of the cartridge with a rotational connection. For example, this connection is typically a threaded type of connection. In order to securely rotate the end fitting onto the connector portion of the cartridge, the user often tightly grips the connector portion of the cartridge with a tool such as a pair of pliers. This can cause undesirable stress on the cartridge and can make coupling of the end fitting to the cartridge difficult. In addition, the cartridge is typically held in a retainer, which is also generally cartridge-shaped or cylindrical. A retaining cap is then used at the end of the retainer opposite to the tip to securely hold the cartridge in place. The retaining cap also provides an input port for pressurized fluid, such as air, used to move the piston. Oftentimes, when rotating end fittings onto the connector portion of the cartridge, which extends through an open end of the retainer, the cartridge will tend to rotate within the retainer. This further exacerbates the problem of tightening the end fitting.

### SUMMARY OF THE INVENTION

The present invention, in one illustrative embodiment, generally comprises a dispensing assembly including a cartridge and a retainer. The cartridge has a dispensing end and defines a reservoir therein for holding a liquid. The dispensing end includes a connector portion for receiving an end fitting with a rotational connection. The retainer includes a first open end and receives the cartridge such that the connector portion communicates with the first open end in a manner allowing connection of the end fitting. The retainer is coupled with the cartridge in a manner preventing relative rotation between the cartridge and the retainer.

Among other aspects that may be incorporated into the dispensing assembly, for example, the connector portion may include internal threads for mating with external threads associated with the end fitting. The internal surface at the first open end of the retainer can mate with the outer surface of the connector portion in the manner mentioned above, i.e., a manner preventing relative rotation between the cartridge and the retainer. For example, the internal surface at the first open end and the outer surface of the connector portion may have mating sections, such as the flat sections of a hexagon. The dispensing assembly may further comprise a cap that releasably mates with a second open end of the retainer. Although the dispensing assembly may take various forms, for example, the cartridge may further include a piston. In this case, the cap may include an input port for receiving a pressurized fluid and directing the pressurized fluid into the reservoir to move the piston in order to dispense the liquid.

Various additional features and advantages will become apparent upon review of the following detailed description of an illustrative embodiment, taken in conjunction with the accompanying drawings.

### BRIEF DESCRIPTION OF THE DRAWINGS

FIG. 1 is a disassembled perspective view of a dispensing assembly constructed in accordance with an illustrative embodiment.

FIG. 2 is an assembled perspective view of the dispensing assembly illustrated in FIG. 1, and further including an end fitting or dispensing tip.

### DETAILED DESCRIPTION OF THE ILLUSTRATIVE EMBODIMENTS

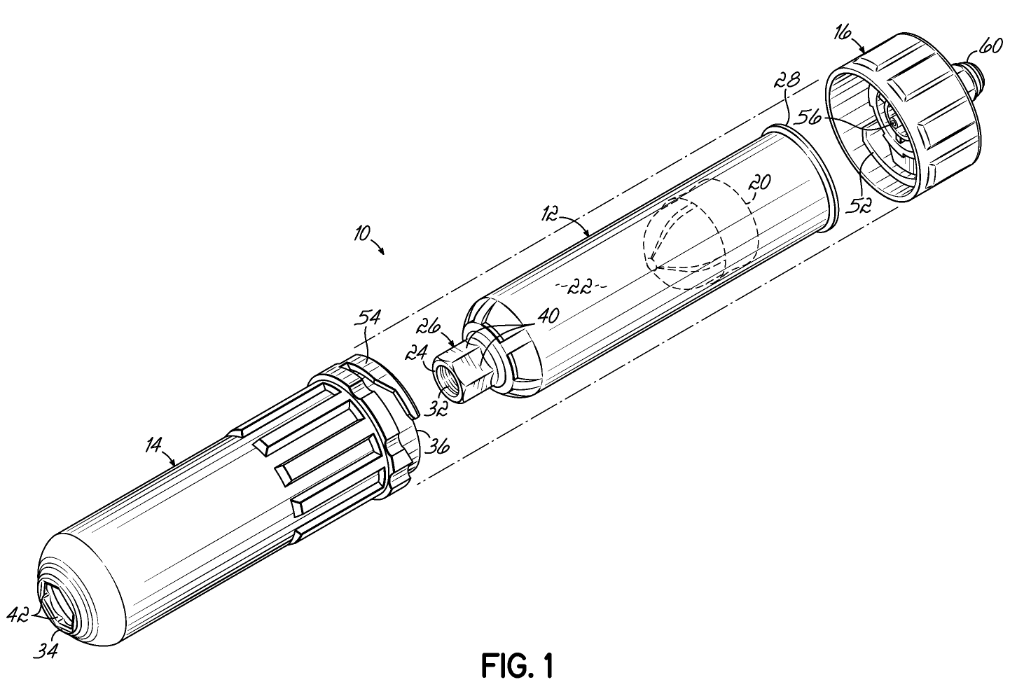

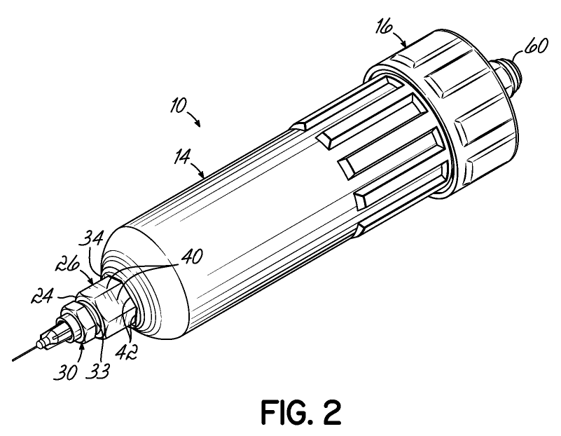

Referring to FIGS. 1 and 2, a dispensing assembly 10 according to one of many possible embodiments is illustrated and generally includes a cartridge 12, a retainer 14, and a cap 16. The cartridge 12 more specifically in this embodiment comprises or contains a movable piston 20 within a reservoir 22 for holding the liquid (not shown) to be dispensed. The cartridge 12 includes a dispensing end 24 with a connector portion 26, and an opposite open end 28. The connector portion 26 receives an end fitting 30 with a rotational connection. For this purpose, the connector portion 26 includes internal threads 32 mating with external threads 33 of the end fitting 30, although various means of facilitating such a connection may be used instead.

The retainer 14 includes a first open end 34 and a second open end 36. The retainer 14 receives the cartridge 12 such that the connector portion 26 communicates with the first open end 34 in a manner allowing connection of the end fitting 30. In the illustrated embodiment, for example, the connector portion 26 extends through the first open end 34 such that it is exposed as shown in FIG. 2.

A coupling is made between the cartridge 12 and the retainer 14 such that relative rotation between the cartridge 12 and the retainer 14 is prevented. In the illustrated embodiment, this coupling takes the form of a hexagonal outer surface defined by flat sections 40 on the connector portion 26 and a corresponding internal hexagonal surface defined by flat sections 42 at the first open end 34 of the retainer 14. Thus, as will be appreciated by reviewing FIG. 2, the mating or engaging hexagonal surfaces 40, 42 prevent relative rotation between the cartridge 12 and the retainer 14. In this manner, rotation of the end fitting 30 onto the connector portion 26 will not tend to rotate the cartridge 12 relative to the retainer 14. Moreover, the connector portion 26 may be grasped with a hex or square wrench or similar tool without placing any significant gripping stress on the connector portion 26. It will be appreciated that other manners of preventing relative rotation between the cartridge 12 and the retainer 14 may be used instead and that the connector portion 26 need not extend through the first open end 34 as shown. Other types of engagement elements or surfaces between the cartridge 12 and the retainer 14 may be used instead.

The cap 16 includes connecting structure 52 configured to rotationally engage, tighten and lock with corresponding connecting structure 54 at the second open end 36 of the retainer 14. Thus, the cap 16 may be tightly connected, locked and sealed on the retainer 14 as shown in FIG. 2. In this connected configuration, pressurized fluid may be directed into an input port 56 of the cap 16 that communicates with the reservoir 22. In this manner, the pressurized fluid, such as air, may be directed into the reservoir 22 and against one side of the piston 20 in order to move the piston 20. This pressurizes the liquid in the reservoir 22 on the opposite side of the piston 20 such that it is dispensed through the end fitting 30. The pressurized fluid may be directly through a conduit (not shown) suitably coupled to a fitting 60 on the cap 16 and communicating with the input port 56 and the open end 28 of the cartridge 12.

While the present invention has been illustrated by a description of an embodiment and while this embodiment has been described in some detail, it is not the intention of the Applicants to restrict or in any way limit the scope of the appended claims to such detail. Additional advantages and modifications will readily appear to those skilled in the art. The various features discussed herein may be used alone or in any combination depending on the needs and preferences of the user. This has been a description of illustrative aspects and embodiments the present invention, along with the preferred methods of practicing the present invention as currently known. However, the invention itself should only be defined by the appended claims. What is claimed is:

1. A dispensing assembly comprising:
a cartridge having a dispensing end and defining a reservoir therein for holding a liquid, said dispensing end including a connector portion for receiving an end fitting with a rotational connection, and
a retainer including a first open end, said retainer receiving said cartridge such that said connector portion communicates with said first open end in a manner allowing connection of the end fitting, and said retainer coupling with said cartridge in a manner preventing relative rotation between said cartridge and said retainer.

2. The dispensing assembly of claim 1, wherein said connector portion includes internal threads for mating with external threads associated with the end fitting, and wherein an internal surface at said first open end of said retainer mates with an outer surface of said connector portion in a manner preventing relative rotation between said cartridge and said retainer.

3. The dispensing assembly of claim 1, wherein an internal surface at said first open end of said retainer mates with an outer surface of said connector portion in a manner preventing relative rotation between said cartridge and said retainer.

4. The dispensing assembly of claim 3, wherein the internal surface at said first open end and the outer surface of said connector portion have mating flat sections.

5. The dispensing assembly of claim 4, wherein the internal surface at said first open end and the outer surface of said connector portion are respectively configured as external and internal hexagonal surfaces.

6. The dispensing assembly of claim 1, further comprising a cap, and wherein said retainer further includes a second open end, said second open end configured to releasably couple with said cap.

7. The dispensing assembly of claim 6, wherein said cartridge further contains a piston, and said cap includes an input port for receiving a pressurized fluid and directing the pressurized fluid into said reservoir to move the piston in order to dispense the liquid.

8. The dispensing assembly of claim 1, further comprising said end fitting releasably coupled to said connector portion.

9. A dispenser assembly comprising:
a cartridge having a dispensing end and defining a reservoir therein for holding a liquid, said reservoir including a piston and said dispensing end including a connector portion for receiving an end fitting with a rotational connection, and
a retainer including a first open end, said retainer receiving said cartridge such that said connector portion extends through said first open end and allows connection of the end fitting, wherein an internal surface at said first open end and an outer surface of said connector portion engage each other in a manner preventing relative rotation between said cartridge and said retainer.

10. The dispensing assembly of claim 9, wherein said connector portion includes internal threads for mating with external threads associated with the end fitting.

11. The dispensing assembly of claim 10, wherein the internal surface at said first open end and the outer surface of said connector portion have mating flat sections.

12. The dispensing assembly of claim 11, wherein the internal surface at said first open end and the outer surface of said connector portion are respectively configured as external and internal hexagonal surfaces.

13. The dispensing assembly of claim 9, further comprising a cap, and wherein said retainer further includes a second open end, said second open end configured to releasably couple with said cap.

14. The dispensing assembly of claim 13, wherein said cap includes an input port for receiving a pressurized fluid and directing the pressurized fluid into said reservoir to move the piston in order to dispense the liquid.

15. The dispensing assembly of claim 9, further comprising said end fitting releasably coupled to said connector portion.
